(19) United States
(12) Patent Application Publication
(10) Pub. No.: US 2008/0061114 A1
(43) Pub. Date: Mar. 13, 2008

(54) Method for the fabrication of low temperature vacuum sealed bonds using diffusion welding

(76) Inventors: Zara Taliashvili, Tbilisi (GE); Lasha Vardosanidze, Tbilisi (GE); Malkhaz Klibadze, Tbilisi (GE); Larissa Jangidze, Tbilisi (GE); Avto Tavkhelidze, Tbilisi (GE)

Correspondence Address: BOREALIS TECHNICAL LIMITED, 23545 NW SKYLINE BLVD, NORTH PLAINS, OR, 97133-9204, US

(21) Appl. No.: 11/983,336

(22) Filed: Nov. 7, 2007

Related U.S. Application Data
(63) Continuation-in-part of application No. 11/585,646, filed on Oct. 23, 2006.
Application No. 11/585,646 is a division of application No. 10/234,498, filed on Sep. 3, 2002, now Pat. No. 7,140,102.
(60) Provisional application No. 60/316,918, filed on Sep. 2, 2001.

(30) Foreign Application Priority Data
Nov. 7, 2006 (GB) GB0622095.8

(51) Int. Cl. B23K 20/00

(52) U.S. Cl. 228/115; 29/25.01; 29/825

(57) ABSTRACT

A method for fabricating low temperature vacuum-sealed bonds through the use of cold diffusion welding comprising the steps of depositing high adhesion layers on the working surfaces of details, depositing soft layers on working surfaces, and the mechanical attachment of the working surfaces under pressure at substantially low temperatures.

### CROSS-REFERENCE TO RELATED APPLICATIONS

This application claims the benefit of U.K. Patent Application No. GB0622095.8, filed Nov. 7, 2006. This application a Continuation-in-Part of U.S. patent application Ser. No. 11/585,646, filed Oct. 23, 2006, which is a Divisional application of U.S. patent application Ser. No. 10/234,498, filed Sep. 3, 2002, which application claims the benefit of Provisional Patent App. No. 60/316,918, filed Sep. 2, 2001. The above-mentioned documents are incorporated herein by reference in their entirety.

### BACKGROUND OF THE INVENTION

The present invention relates to a method for joining metal parts by means of cold diffusion welding. This method allows the fabrication of vacuum-sealed bonds and is particularly of interest to the microelectronics industry, with broader applicability. The present invention also relates to diode devices fabricated in part by cold diffusion welding techniques, in particular, to diode devices in which the separation of the electrodes and the angle between the electrodes is set and controlled using piezo-electric, positioning elements. These include thermionic converters and generators, photoelectric converters and generators, and vacuum diode heat pumps. It is also related to thermotunnel converters.

Many techniques have been developed to join articles together for a wide range of situations. Mechanical, electrical, or thermal methods may be used depending on the bond desired. Especially for the microelectronics industry, it is important that the bonding be accomplished without damaging the already present microelectronic device.

Soldering, a common approach to bonding requirements in microelectronic devices, has disadvantages in some applications however. Fluxes and acids are often needed to clean and etch the surfaces to be bonded, leaving residue and possibly damaging the microelectronic device. Furthermore, any known low temperature solder does not have high strength after bonding.

Diffusion welding is a solid-state process that produces no melting, little distortion and much lower temperature exposures than those found in fusion welding. It offers many potential advantages over other conventional welding processes. However, even the significantly reduced temperatures used for diffusion welding are higher than ideal. The typical diffusion welding process utilizes temperatures higher than 70% of the metal's melting point, often reaching close to 100%.

U.S. Pat. No. 5,3161,971 discloses an intermediate-temperature diffusion welding process in which two surfaces are pressed together at a temperature of from about 125 C to 250 C.

This present invention aims to fulfill the need of fabricating bonds through diffusion welding at lower temperatures.

The use of individual actuating devices to set and control the separation of the electrodes using piezo-electric, electrostrictive or magnetostrictive actuators in a nanogap diode is disclosed in U.S. Pat. No. 6,720,704. This approach avoids problems associated with electrode spacing changing or distorting as a result of heat stress.

The use of composite materials as matching electrode pair precursors is disclosed in U.S. Pat. No. 7,140,102 (12070). The approach comprises the steps of fabricating a first electrode with a substantially flat surface; placing over the first electrode a second material that comprises a material that is suitable for use as a second electrode, and separating the composite so formed along the boundary of the two layers into two matched electrodes.

A Nanogap diode in which a tubular actuating element serves as both a housing for a pair of electrodes and as a means for controlling the separation between the electrode pair is disclosed in U.S. Pat. No. 7,169,006 (12078).

### BRIEF SUMMARY OF THE INVENTION

From the foregoing, it is obvious that an improved method for joining two pieces of material is necessary. In accordance with the present invention, a method for fabricating low temperature vacuum-sealed bonds is provided through the use of cold diffusion welding comprising the steps of depositing high adhesion layers on the working surfaces of details, depositing soft layers on working surfaces, and the mechanical attachment of the working surfaces under pressure at substantially low temperatures.

In another aspect, the present invention contemplates a bonded junction comprising: a first piece on which is formed a first high adhesion layer and a first soft layer, and a second piece on which is formed a second high adhesion layer and a second soft layer. The two are joined by a welded layer between the soft layers formed according to the method of the invention.

In a further aspect the present invention contemplates a diode device comprising a piezo housing, on each end of which is bonded a support bearing an electrode, in which the bonding is accomplished according to the method of the invention.

Advantages of the method of the present invention include minimal deformation and low distortion of the bonded materials. Thermal stress is reduced and the area of the bond has properties and microstructures similar to those of the base materials. The process is entirely solid state, and neither the pieces nor the bonding materials are melted during the process. Additionally, the maximum temperature is within the acceptable heating range for most microelectronic devices, which can be damaged if heated to a too high temperature. Further advantages include a simpler way to join different materials as opposed to progressive deposition and etching, and significant savings as compared to other prior art welding methods.

### BRIEF DESCRIPTION OF THE SEVERAL VIEWS OF THE DRAWING

FIG. 1 shows a schematic displaying the assembly process of this invention.

FIG. 2 shows a schematic of the present invention after the bonding process.

FIG. 3 a diagrammatic representation of an electrode composite on a silicon wafer.

FIGS. 4 and 5 show diode devices bonded by the method of the present invention.

### DETAILED DESCRIPTION OF THE INVENTION

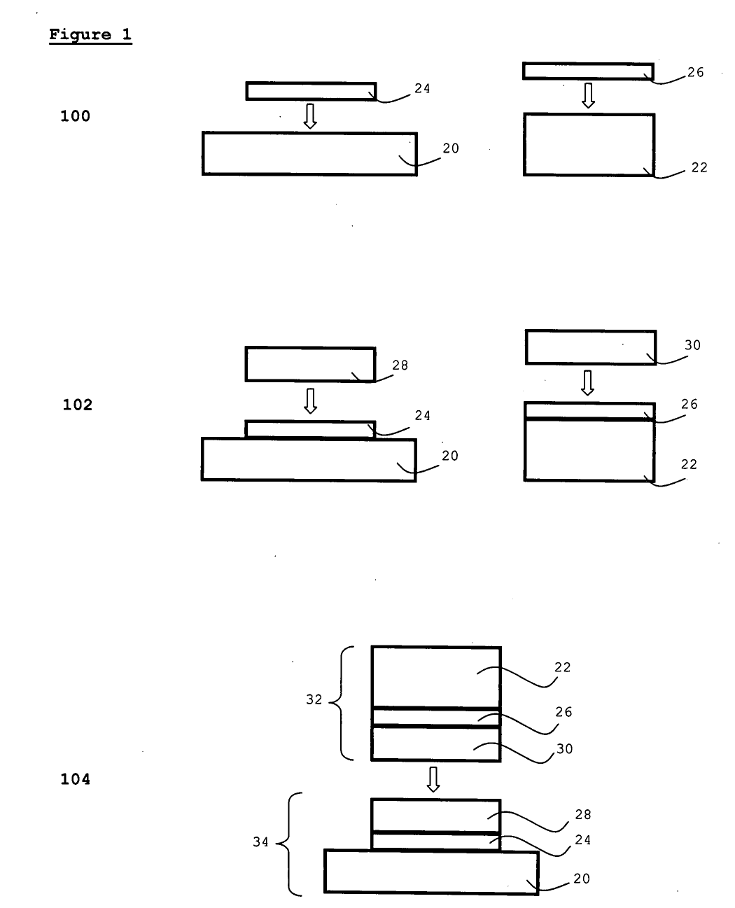

Referring to FIG. 1, in step 100, high adhesion layers 24 and 26, which may comprise titanium (Ti) or titanium and silver (Ti/Ag), are deposited in a vacuum onto working layers 20 and 22. It is important that the vacuum deposition chamber and the working layers be cleaned by plasma cleaning before this deposition step. Soft layers 28 and 30 (also referred to as “low adhesion layers”), which may comprise indium (In), indium-tin (In—Sn), or tin-lead (Sn—Pb) among others, are deposited in step 102 onto layers 24 and 26 through the use of different methods such as vacuum deposition, electrochemical growth, or other methods. The roughness and curvature over the whole surface should be less than the thickness of the soft layer 24 or 26. In step 104, detail 32, comprised of silicon wafer 20, high adhesion layer 24, and soft layer 28, and detail 34, comprised of piezo cylinder 22, high adhesion layer 26, and soft layer 30, are placed in contact having soft layers 28 and 30 in a facing relation. Details 32 and 34 should be pressed together and brought to an elevated temperature for a predetermined amount of time. The needed pressure, temperature, and time are determined with regard to the particular soft layer used.

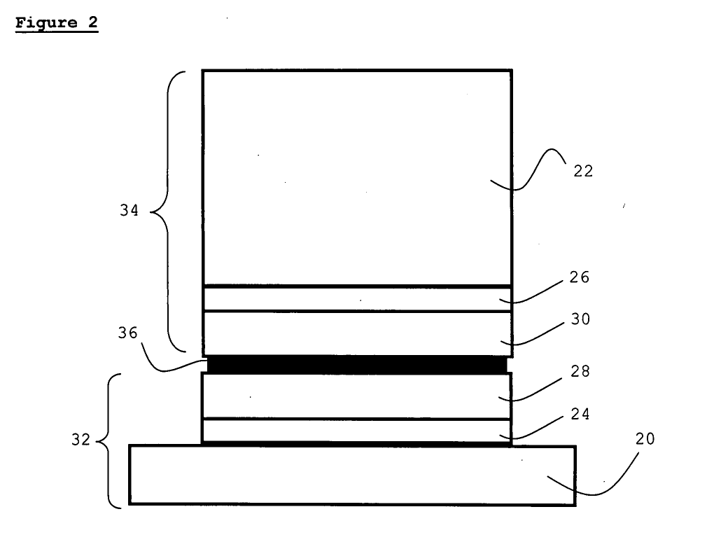

FIG. 2 depicts the present invention following the bonding process. During the process of bonding, the mixture of the soft layers 28 and 30 occurs and a welded area 36 is formed.

In one particular embodiment, high adhesion layer 24 comprised of Ti is deposited on a silicon wafer having a diameter of 20 mm and a thickness of 2 mm following the plasma cleaning of the vacuum chamber and silicon wafer. Argon is utilized for the cleaning process and the pressure is reduced to 1×10ˆ−1 torr for 15-20 minutes, and I=100 mA and V=300 V. The Ti is deposited onto wafer 20, kept at 60 C, for 5 seconds to a thickness of 700-900 A.

The plastic/soft layer 28 in this particular embodiment is comprised of InSn and is deposited for 20 seconds to a thickness of 3 microns. There is a 10 second interval between depositions, and at the end of the deposition process, wafer 20 temperature should be 65 C. The deposition happens in situ.

Working layer 22 of this particular embodiment is a piezo element of cylindrical shape having a height of 8 mm, an internal diameter of 15 mm, and an external diameter of 17 mm. Piezo cylinder 22 and the vacuum chamber are plasma cleaned using Ar at 1×10ˆ−1 torr for 15-20 minutes where I=100 mA and V=300 V. The piezo cylinder 22 is heated for 2 minutes to a temperature of 70 C. A high adhesion layer 26 comprised of Ti/Ag is deposited on the end surfaces of the cylinder. Ti is deposited at a wafer temperature of 60 C for 5 seconds to a thickness of 700-900 A. Ag is then deposited for 8 seconds to a thickness of 3500 A. During the deposition of layer 26, comprised of Ti and Ag, the temperature rises to 80 C.

The soft layer 30 of this particular embodiment is comprised of InSn and is deposited for 20 seconds to a thickness of 3 microns. There is a time interval of 10 seconds between the deposition of layer 26 and layer 30. The temperature rises to 100 C during the deposition of layer 30.

Detail 32, comprised of silicon wafer 20, high adhesion layer 24, and soft layer 28, and detail 34, comprised of piezo cylinder 22, high adhesion layer 26, and soft layer 30, are placed in contact having soft layers 28 and 30 in a facing position. Special guides are used to press detail 32 to detail 34 with regulated pressure. For the details 32 and 34 of the particular abovementioned embodiment, the pressure is 2.6-2.8 mPa. Details 32 and 34 are pressed together at room temperature for 15 hours and at 100 C for 1 hour. During this process of bonding, the mixture of the soft layers 28 and 30 occurs and a welded area 36 is formed.

Leak detector tests of the finished device showed no leaks.

Whereas the abovementioned embodiment utilizes vacuum deposition for the deposition of the soft layers 28 and 30, electrochemical growth may also be used. Electrochemical growth is much simpler and obtains results similar to those of vacuum deposition, with leaks at the level of 10ˆ−5 torr. Electrolytic composition for the growth of the InSn compound is InCl2 at 40 g/liter, SnCl2×2H2O at 15 g/liter, and carpenter glue at 2 g/liter. A current density of 0.7 A/dmˆ2 is employed at an electrolyte temperature of 20-25 C.

The approach disclosed above may be applied to the manufacture of a diode device having an adjustable vacuum nanoscale gap in which the electrodes are mutually repeating, or matching, or conformal.

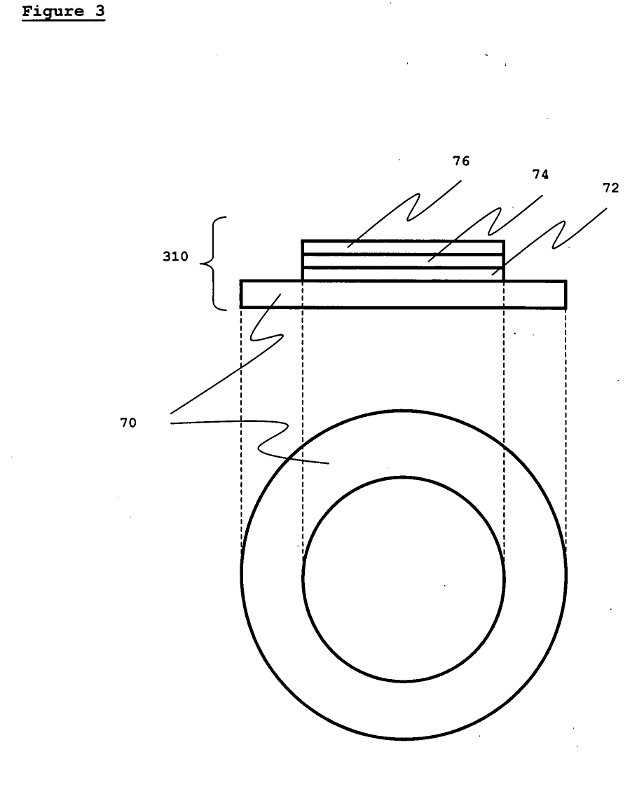

Referring now to FIG. 3, which shows a composite intermediate 310, a doped silicon wafer 70 is used as the substrate. The dopant is n type, and the conductivity of the doped silicon is on the order of 0.05 Ohm cm. A 0.1 μm thick titanium film is deposited over the silicon substrate using DC magnetron sputtering method. A round metallic mask with a diameter of 28 mm is used for the titanium film deposition. After deposition, the titanium is backed with silicon to achieve maximum adhesion of the titanium film to the silicon substrate. Next is the in situ deposition of 1 μm thick silver film using the same method. Deposition regimes for silver are chosen to achieve optimum adhesion of silver to the titanium film. (The optimum adhesion is much less than the adhesion usually used in microelectronics processes.) A layer of copper 500 μm thick is grown electrochemically on the silver film. The copper is grown using ordinary electrochemical growth.

Next, the sandwich on the border of titanium and silver films is opened. Once we have low adhesion between the titanium and silver films, the sandwich opens without considerable deformation of the electrodes. In this way, two conformal electrodes are fabricated. With conformal electrodes it is then possible to achieve tunneling currents over broad areas of the electrodes.

The process uses metallic masks to define the shape of the films to avoid exposing the samples to the atmosphere. This simplifies sample preparation and avoids problems connected with the cleaning of the electrode surfaces.

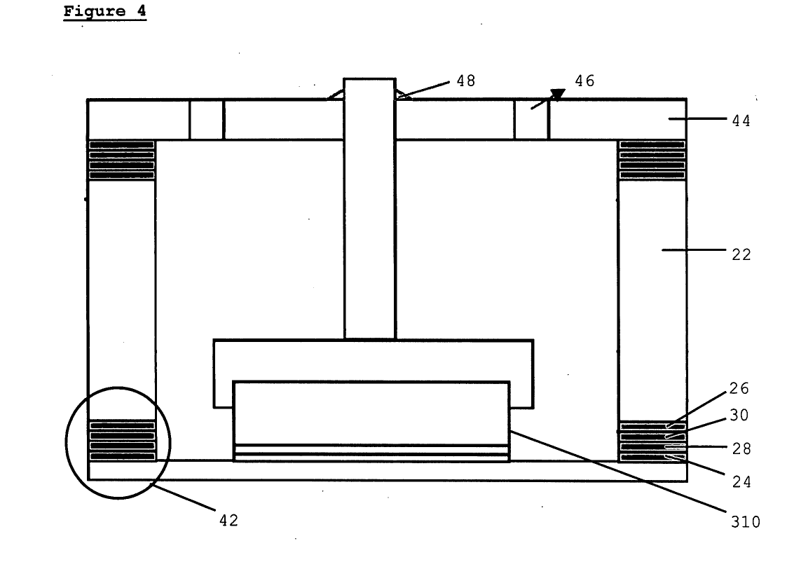

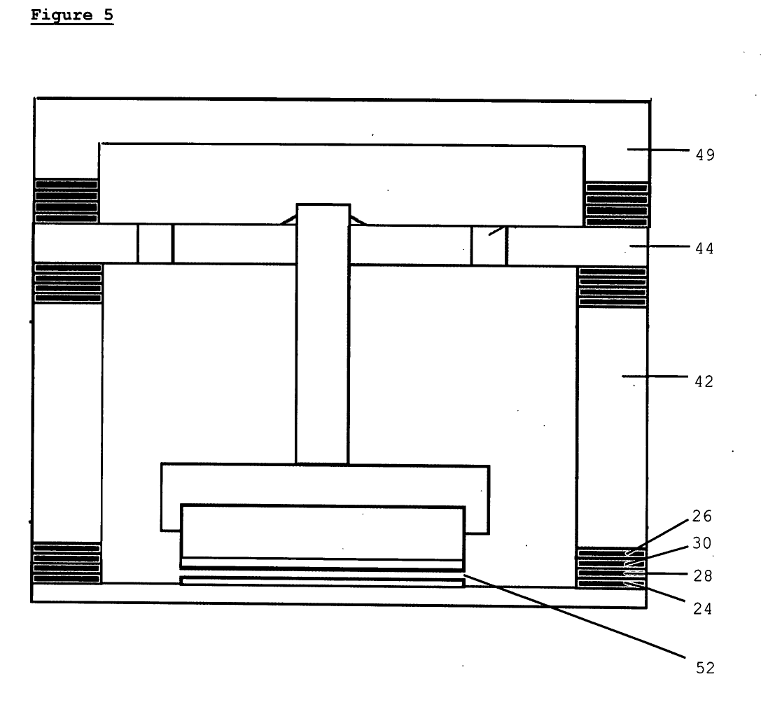

Referring now to FIG. 4, composite 310 is mounted in a housing which comprises piezo element 22 joined by means of the diffusion welding approach disclosed above to the doped silicon wafer at one end and at the other end to a detail 44 having openings 46 for the evacuation of the device. The regions circled and labeled 42 in FIG. 4 correspond to the elements shown in FIG. 2. High adhesion layers 26 are formed on both ends of the piezo-element, and, similarly, high adhesion layers 24 are formed on the silicon wafer, and on detail 44. Plastic layers 28 and 30 are formed on the high adhesion layers, and the component parts pressed together. Referring now to FIG. 5, the device shown in FIG. 4 is evacuated and an upper metal roof 49 is attached by the diffusion welding technique disclosed above. By not exposing the electrode surfaces to the atmosphere, oxidation is avoided. The sandwich is opened by cooling it down from room temperature to approximately 0° C. or heating it up to 40° C. Because copper and silicon have different Thermal Expansion Coefficients (TEC) the two electrodes separate in the process of cooling or heating. If the adhesion between the titanium and silver films is low enough, the sandwich opens without leaving considerable deformation in the electrodes. On the other hand, the adhesion of silver to titanium must be high enough to prevent electrochemical liquid from entering between the films during the electrochemical growth of copper. Precise adhesion control between the titanium and silver films is therefore important. Finally, the electrodes are separated by the operation of the piezo elements to form a pair of conformal electrodes separated by a nanoscale vacuum gap 52, typically of the order of 10-500 nm. In this respect, the two electrodes are said to be conformal because where one surface has an indentation, the other surface has a protrusion and vice versa. Thus when matched, the two surfaces are substantially equidistant from each other throughout their operating range.

Although particular embodiments of the invention have been described in detail for purposes of illustration, various modifications may be made without departing from the spirit and scope of the invention. The effective applied pressure, deposition times, and bonding times all depend on the composition of the particular plastic layer and the geometry of the bonded region. Additionally, it is possible to further heat the details to reduce the exposure time, in which case the heating step should be done in a vacuum to avoid oxidation. Accordingly, the invention is not to be limited except as by the appended claims.

1. A method for joining two pieces together, comprising the steps of:
depositing a high adhesion layer on a surface of two pieces to be bonded;
depositing a soft layer on said high adhesion layers;
pressing said two pieces to be bonded together first at room temperature and then at approximately 100 C for a time sufficient to allow said soft layers to mix.

2. The method of claim 1, wherein said high adhesion layer is comprised of a material from the group consisting of: Ti and Ti/Ag.

3. The method of claim 1, wherein said soft layer is comprised of a material from the group consisting of In, In—Sn, Sn—Pb.

4. The method of claim 1, wherein said first piece to be bonded is a silicon wafer and said second piece to be bonded is a piezo cylinder.

5. The method of claim 1, wherein said step of depositing a high adhesion layer is vacuum deposition.

6. The method of claim 1, wherein said step of depositing a soft layer is vacuum deposition.

7. The method of claim 1, wherein the step of depositing a soft layer comprises electrochemical growth.

8. The method of claim 1, wherein said sufficient time is 15 hours at room temperature and 1 hour at 100 C.

9. A bonded junction comprising:
(a) a first piece;
(b) a first high adhesion layer in contact with said first piece;
(c) a first soft layer in contact with said first high adhesion layer;
(d) a welded layer in contact with said first soft layer;
(e) a second soft layer in contact with said welded layer;
(f) a second high adhesion layer in contact with said second soft layer; and
(g) a second piece in contact with said second high adhesion layer;
wherein said welded layer comprises a mixture of said first and said second soft layers and is formed according to the process of claim 1.

10. The bonded junction of claim 9 wherein said first piece comprises a silicon wafer and said second piece is comprises a piezo cylinder.

11. The bonded junction of claim 9 wherein said high adhesion layer is comprised of a material from the group consisting of: Ti and Ti/Ag.

12. The bonded junction of claim 9 wherein said soft layer is comprised of a material from the group consisting of In, In—Sn, Sn—Pb.

13. A diode device comprising:
(a) a piezo housing;
(b) a first electrode attached to a first support, said first support attached to one end of said piezo housing by bonding means;
(c) a second electrode attached to a second support, said second support attached to the other end of said piezo housing by bonding means;
wherein said bonding means comprises the bonded junction of claim 10.

14. The diode device of claim 13 wherein said high adhesion layer is comprised of a material from the group consisting of: Ti and Ti/Ag.

15. The diode device of claim 13 wherein said soft layer is comprised of a material from the group consisting of In, In—Sn, Sn—Pb.

16. The diode device of claim 13 wherein said electrodes are separated by a nanoscale gap.
